(19) United States
(12) Patent Application Publication
(10) Pub. No.: US 2010/0193118 A1
(43) Pub. Date: Aug. 5, 2010

(54) HEAT WELDING METHOD AND APPARATUS

(76) Inventors: John D. Rouse, Oscoda, MI (US); Jeremy R. Lee, Oscoda, MI (US)

Correspondence Address: REISING ETHINGTON P.C., P O BOX 4390, TROY, MI, 48099-4390, US

(21) Appl. No.: 12/700,404

(22) Filed: Feb. 4, 2010

Related U.S. Application Data
(60) Provisional application No. 61/149,981, filed on Feb. 4, 2009.

(51) Int. Cl. B32B 38/04; B26D 1/12; B29C 65/10

(52) U.S. Cl. 156/258; 407/30; 156/497

(57) ABSTRACT

A method is provided for heat welding plastic material. A welding tip is provided and is configured to slidably receive a welding rod and to direct a flow of hot air toward such a welding rod from a hot air source to melt a leading end of the rod as the welding rod is advanced therethrough. Plastic sheets are positioned edgewise adjacent one another to form a seam therebetween. A v-shaped groove is cut into and along the seam, and the sheets are then welded together along the seam by feeding a welding rod through the welding tip while positioning and moving the welding tip adjacent and along the seam as the welding tip directs hot air to heat the welding rod and the sheets along the groove such that the welding rod flows into the groove and welds to respective sheet surfaces defining the groove. Also provided is an insert for making the v-shaped groove.

### CROSS-REFERENCE TO RELATED APPLICATION

This application claims the benefit of U.S. Provisional Application No. 61/149,981, filed Feb. 4, 2009. The disclosure of the above application is incorporated herein by reference.

### FIELD OF THE INVENTION

The present invention generally relates to a method and apparatus for heat welding plastic material.

### BACKGROUND OF THE INVENTION

High speed welding of plastic components is generally known in the art. Currently, high speed welding tips can be used on heat guns for the purpose of accomplishing relatively high speed plastic welding between two plastic components. Typically, such high speed plastic welding tips incorporate an attachment portion that has a generally cylindrical input end for attachment to a heat gun. The attachment portion tapers from its generally cylindrical area at the input end to a generally oval output opening at an opposite output end. The output end is used to direct the flow of hot air used in the welding process. A welding rod feed section is secured to the output end. Typically, the welding rod feed section is cylindrical having a generally circular cross-section for receiving a plastic welding rod.

In one known method of securing two plastic components, such as floor segments, the plastic components are adhered to a substrate using a suitable adhesive. The edges of the plastic material abut one another forming a seam therebetween. A generally semi-circular groove is cut over and along the seam and sections equally on each side of the seam in each plastic sheet. The depth of the groove approximates one-half of the thickness of the plastic sheet. A round plastic welding rod is placed in the welding rod feed section of the welding tip that is affixed to the heat gun. The heat gun is then activated to a temperature of about 650° to 700° F. The heat gun and welding tip heat the surfaces of the adjacent plastic sheets as well as the welding rod. The plastic welding rod flows from the tip and into the groove, covering the seam between the adjacent plastic sheets.

While this method is generally effective, certain limitations, primarily related to the speed of the welding are inherent. Further, the depth of the groove is limited due to the shape of the rod to be used for the welding procedure, which may limit the strength of the weld.

### SUMMARY OF THE INVENTION

According to an embodiment a method is provided for heat welding plastic material. The method includes providing a welding tip configured to slidably receive a welding rod and to direct a flow of hot air toward such a welding rod from a hot air source to melt a leading end of the rod as the welding rod is advanced therethrough, positioning plastic sheets edgewise adjacent one another to form a seam therebetween. A v-shaped groove is cut into and along the seam, and the sheets are then welded together along the seam by feeding a welding rod through the welding tip while positioning and moving the welding tip adjacent and along the seam as the welding tip directs hot air to heat the welding rod and the sheets along the groove such that the welding rod flows into the groove and welds to respective sheet surfaces defining the groove.

According to an embodiment a method is provided for heat welding plastic material. The method includes providing a welding tip configured to slidably receive a welding rod and to direct a flow of hot air toward such a welding rod from a hot air source to melt a leading end of the rod as the welding rod is advanced therethrough. Plastic sheets having a depth are positioned edgewise adjacent one another to form a seam therebetween. A groove is cut into and along the seam such that the groove extends a depth less than the thickness of either sheet but great enough to allow sufficient heat to reach a lower end of the seam to insure that directly abutting material of the sheets flows together and welds at the lower end of the seam. The sheets are welded together along the seam by feeding a welding rod through the welding tip while positioning and moving the welding tip adjacent and along the seam as the welding tip directs hot air to heat the welding rod and the sheets along the groove such that the welding rod flows into the groove and welds to respective sheet surfaces defining the groove.

According to an embodiment a cutting insert is provided for cutting a v-shape groove in plastic material. The cutting insert comprises a base portion configured to mount the insert to a blade of a power groover and a cutting portion. The cutting portion has a v-shaped profile configured to cut a v-shaped groove in a surface when rotated into contact with such a surface by a power groover blade upon which the insert is mounted.

According to an embodiment a welding tip is provided for welding plastic material. The welding tip includes a welding rod feed section comprising a passage configured to slidably receive a welding rod and a base secured to the welding rod feed section. The base is configured to engage a heat gun exhaust muzzle and to direct the flow of hot air from the heat gun muzzle toward a welding rod carried by the feed section. The feed section is configured to slidably receive and allow a welding rod having a generally triangular cross-section, to be advanced therethrough as a forward end of the welding rod is heated and melted by hot air directed by the base.

According to an embodiment a welding tip assembly is provided for welding plastic material. The assembly comprises a welding rod, a welding rod feed section comprising a passage configured to slidably receive a welding rod, and a base secured to the welding rod feed section. The base is configured to engage a heat gun exhaust muzzle and to direct the flow of hot air from the heat gun muzzle toward a welding rod carried by the feed section. The welding rod has a general shape of an elongated triangular prism and the feed section is configured to slidably receive and allow the welding rod to be advanced therethrough as a forward end of the welding rod is heated and melted by hot air directed by the base.

### BRIEF DESCRIPTION OF THE DRAWINGS

The present invention will become more fully understood from the detailed description and the accompanying drawings, wherein:

FIG. 1 is a plan view of a welding tip configured in accordance with one embodiment of the present invention;

FIG. 2 is an end view of the welding tip of FIG. 1;

FIG. 3 is a perspective view partially in cross-section of two sheets welded together by a method performed in accordance with one embodiment of the present invention;

FIG. 4 is a cross-sectional view of a welding rod configured in accordance with one embodiment of the invention;

FIG. 5 is a plan view of an insert for a cutting tip configured in accordance with one embodiment of the invention;

FIG. 6 is a side view of the cutting tip of FIG. 5; and

FIG. 7 is a flow chart showing a method for heat welding plastic material according to an embodiment of the invention.

### DETAILED DESCRIPTION OF THE PREFERRED EMBODIMENTS

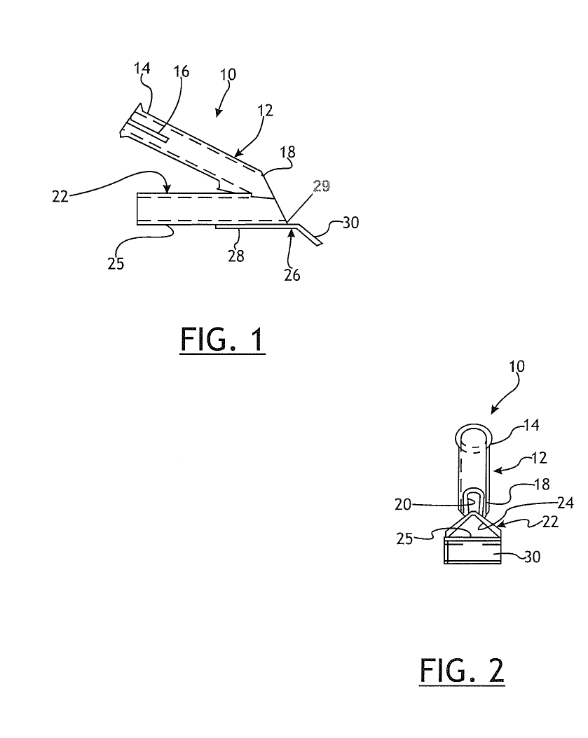

FIG. 1 shows a plan view of a welding tip configured according to one embodiment of the present invention. The welding tip is generally shown at 10 in FIGS. 1 and 2 and is adapted to be received on a heat gun (not shown) of a type well-known in the art. Suitable heat guns for use in connection with the welding tip 10 include, but are not limited to, heat guns made by LEISTER®, FORSTHOFF®, and STEINEL®. It will be appreciated that any suitable heat gun may be used in accordance with the present invention.

The welding tip 10 may include a base as is generally indicated at 12 in FIGS. 1 and 2. The base 12 may include a generally cylindrical attachment portion 14 that is adapted or configured to engage or be removably mounted on a heat exhaust muzzle of a heat gun (not shown). The attachment portion 14 may include one or more longitudinal slots 16 spaced parallel and circumferentially around a circumference of the attachment portion 14. The longitudinal slots 16 give the attachment portion 14 sufficient flexibility to firmly slide over and engage a heat gun muzzle via an interference fit. The base 12 may taper inward, i.e., reduce in cross-sectional area, from the attachment portion 14 to an output end 18. The base 12 directs a flow of hot air from a heat gun muzzle to and through an output end 18 of the base 18 toward a forward end of a welding rod carried by a welding rod feed section 22 of the welding tip 10, as will be described more fully below. The output end 18 of the welding tip base 12 may have a generally oval-shaped opening 20.

The welding rod feed section 22 may be configured to slidably receive and allow a welding rod 60, e.g., a welding rod 60 having a generally triangular cross-section, to be advanced therethrough as a forward end of the welding rod 60 is heated and melted by hot air directed by the welding tip base 12 during a welding operation. The welding rod feed section 22 may be generally tubular and may be secured to the output end 18 of the base 12 by any suitable means. The welding rod feed section 22 may include a generally tubular opening or passage 24 having a cross-sectional shape that may be constant along at least a portion of a length of the passage 24 and slightly larger than but complementary to the cross-sectional shape of a welding rod 60 to be received in the passage 24. In one preferred embodiment, the welding rod feed section 22 has generally triangular cross-section along at least a portion of its length providing a generally triangular opening or passage 24 therethrough, as best seen in FIG. 2, to accommodate welding rods having a complementary, generally triangular cross-sectional shape, i.e., the general shape of an elongated triangular prism.

The welding tip 10 may further include a lip as is generally indicated at 26 in FIG. 1. The lip 26 may include a securing portion 28 for securing the lip 26 to one wall 25 of the welding rod feed section 22. The securing portion 28 may extend beyond a trailing edge 29 of the welding rod feed section 22, as best seen in FIG. 1. The lip 26 may further include a flange 30 extending from the securing portion 28 at an angle relative to the one wall 25 of welding rod feed section 22. In one preferred embodiment, the flange 30 extends at an angle of about 45° relative to the plane of the one wall 25 of the welding rod feed section 22.

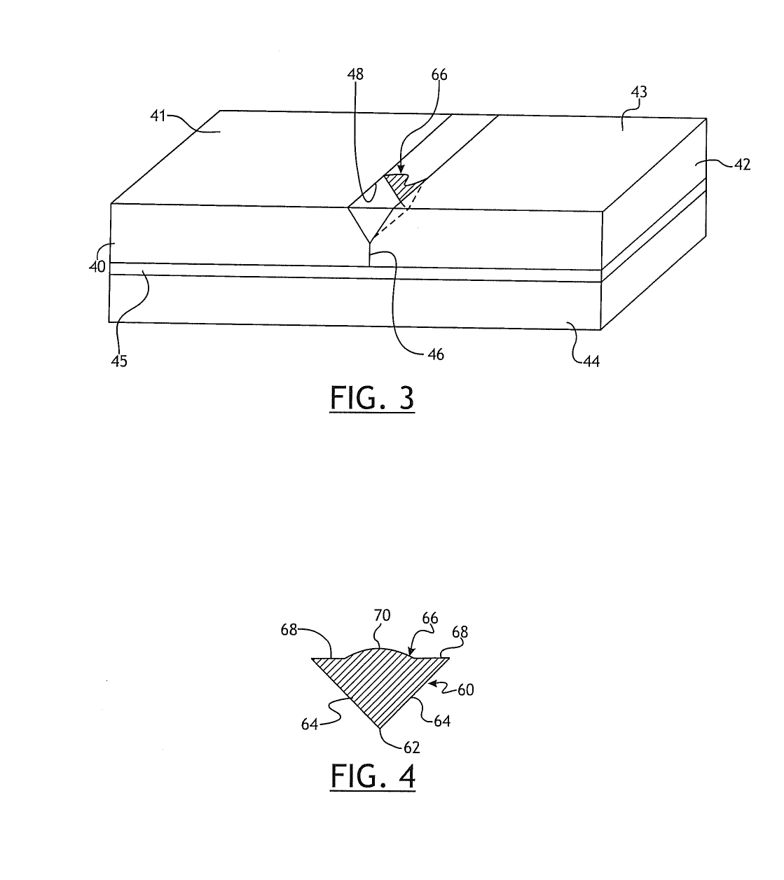

FIG. 3 is an orthogonal view, partially in cross-section, of two sheets 40, 42 welded end-to-end in accordance with one embodiment of the method of the present invention. As shown in FIG. 3, a first sheet 40 may be positioned adjacent and, alternatively, abutting a second sheet 42. The sheets 40, 42 may preferably comprise the same material. The sheets may preferably comprise a plastic material and most preferably a thermoplastic material. The sheets 40, 42 may comprise a vinyl material, and preferably may comprise polyvinylchloride. The sheets 40, 42 may further include suitable fiber reinforcement. One suitable material for the sheets 40, 42 is sold under the name PROTECTALL® by Oscoda Plastics, the Assignee of the present invention. It will be appreciated that while a preferred material is polyvinylchloride, any suitable material may be used for the sheets within the context of the present invention. It is most preferred, in order to achieve a consistent result, that the two sheets 40, 42 be made of similar, and most preferably, the same materials. Further, it is preferred that the sheets 40, 42 have the same thickness. It will be appreciated, however, that sheets 40, 42 need not and may not have the same thickness.

As is also shown in FIG. 3, the sheets 40, 42 may be secured to a suitable substrate 44. The substrate may comprise any material. By way of non-limiting example, the substrate 44 may comprise wood, such as plywood or oriented strand board. Similarly, the substrate 44 may comprise concrete. While wood and concrete are specifically discussed as being suitable substrate 44 material, it will be appreciated that the substrate 44 may comprise any suitable material or materials within the context of the present invention.

The sheets 40, 42 may be secured to the substrate 44 via a suitable adhesive 45. One such suitable adhesive 45 that may be used may comprise an epoxy adhesive. However, it will be appreciated that any suitable adhesive 45 may be used to secure the sheets 40, 42 to the substrate 44.

According to the embodiment of FIG. 3, the sheets 40, 42 may be laid adjacent one another with respective facing edges of the sheets 40, 42 abutting one another to provide a butt joint therebetween, the butt joint having or forming a seam 46 extending between the sheets 40, 42. It is preferred that the sheets 40, 42 be positioned such that the seam 46 is relatively tight. A groove 48 may then be cut into sheets 40, 42 at and along the seam 46 from top surfaces 41, 43 of sheets 40, 42, respectively. It is preferred that the groove 48 have a generally v-shaped cross-section as shown in FIG. 3. It is preferred that the groove 48 have a depth that is less than the thickness of either sheet 40, 42; but great enough to insure that sufficient heat reaches a lower end of the seam 46 to insure that the directly abutting material of sheets 40 and 42 flows together and welds at the lower end of the seam 46. Preferably, the groove 48 may have a depth greater than half the thickness of the sheets 40, 42. Where the two sheets 40, 42 differ in thickness, it's preferred that the groove 48 have a depth greater than half the thickness of the thinnest of the two sheets 40, 42. By way of example, on sheets 40, 42 that are both ¼″ thick, it is preferred that the groove 48 have a depth greater than ⅛″, and more preferably, it is preferred that the groove 48 have a depth set to 1/16″ above the bottom surfaces of the sheets 40, 42, i.e., above the lower end of the groove 48. That is, for ¼″ sheets, it is preferred that the groove 48 have a depth of about 3/16″ from the top of the sheets 40, 42. The groove 48 may preferably be cut to run symmetrical about and along the seam 46. Further, the groove may be cut so as to have an angle at its deepest point of about 90°.

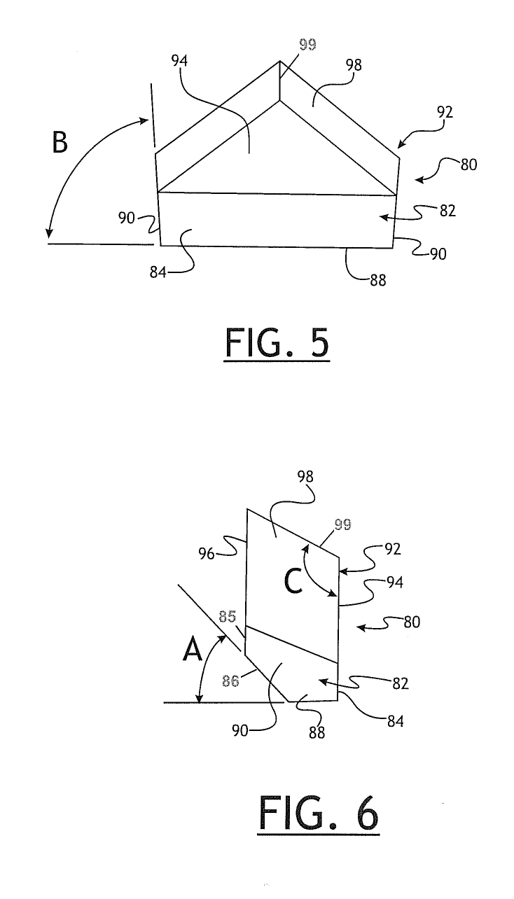

The groove 48 can be cut into the sheets 40, 42 in any suitable manner using any suitable tool or tools. One such suitable manner is to use a power groover utilizing a suitable cutting device or cutting insert; as will be more fully described below in connection with FIGS. 5 and 6; that can produce a generally v-shaped groove between the sheets 40, 42. It will be appreciated, however, that a power groover need not necessarily be used. In some instances, a power groover cannot be used because seam 46 cannot be reached by a power groover. Accordingly, the groove 48 may be made using hand tools such as a utility knife and a straight edge (not shown). The groove 48, if made by hand tools, should have the same v-shaped configuration as can be achieved using a power groover. The cutting of a v-shaped groove 48 allows for a groove depth that can be deeper than was achievable in the prior art. Without being bound to any specific theory, it is believed that a relatively deeper groove 48, as described above, than was achievable in the prior art, results in a stronger weld and therefore a stronger joint between the sheets 40, 42.

FIG. 4 is a cross-sectional view of a welding rod, generally indicated at 60, which is configured according to one embodiment. As shown, the welding rod 60 may be shaped to complement the shape of a groove 48 cut along a seam 46 between sheets 40, 42 to be welded. As is also shown in FIG. 4, the welding rod 60 may have a generally triangular profile to complement a generally V-shaped groove profile, and can be of any desired length. In one embodiment, the cross-sectional shape of the welding rod 60 is constant along the entire length. In one embodiment, the triangular profile may comprise a right triangle with the opposite angles each being 45°. The welding rod 60 may include a bottom 62 defined by the 90° angle. The welding rod 60 may further include side walls 64 extending from the bottom 62. By using a welding rod 60 having the side walls 64 angled to generally match the angle of corresponding side walls of a groove 48 formed along a seam 46 between sheets 40, 42 to be welded, a more uniform weld may be achieved. The side walls 64 may be of any contour that preferably complements that of corresponding groove side walls, and may, as shown in the drawings, be generally planar. The welding rod 60 may further include a top surface generally indicated at 66 in FIG. 4. The top surface 66 may have generally planar end portions 68 at outer edges adjacent the side walls 64 thereof. In one embodiment, and as is also shown in FIG. 4, an elongated longitudinally-extending semi-circular or radiused portion or longitudinal ridge 70 intermediate the generally planar edge portions 68 may extend integrally from and along the top surface 66 of the rod 60. The ridge 70 provides an elongated longitudinally-extending convex surface that protrudes outwardly from along the top 66 of the welding rod 60, but the welding rod 60 is proportioned so that, despite the longitudinal ridge 70, the rod 60 can be received in a welding rod feed section 22 having a generally triangular cross-section.

The welding rod 60 may preferably, but not necessarily, be made from a similar material to that of the sheets 40, 42. In one embodiment, the welding rod 60 may comprise polyvinylchloride. Where a welding rod 60 having a generally triangular configuration is to be used, the rod 60 may be made from a harder material than if the rod 60 were to have a shape, e.g., a generally cylindrical shape having a generally circular cross section, as is known to be used in prior applications. By way of non-limiting example, the welding rod may comprise PVC (polyvinylchloride) having a durometer hardness of 90 Shore A.

A cutting insert that can be used to cut the v-shaped groove 48 between abutting sheets 40, 42, rather than half-round or trapezoidal grooves known in the art, is generally shown at 80 in FIGS. 5 and 6. One or more such cutting inserts 80 can be placed or attached in respective positions circumferentially spaced around a circular blade of a power groover of a type that is well-known, such that rotation and engagement of the blade against and along the seam 46 cuts the v-shaped groove 48. Suitable power groovers include, but are not limited to, those made by LEISTER®.

The cutting insert 80 may have a base portion, as is generally indicated at 82 in FIGS. 5 and 6, which is configured to mount the insert to an outer circumference of a circular blade of a power groover. The base portion 82 may have a front surface 84 that extends generally perpendicular from a bottom surface 88 of the base portion 82 and a generally parallel back surface 85 The base portion 82 may also have a bevel surface 86 that may extend between the bottom surface 88 and the back surface 85 at an angle A relative to the bottom surface 88. As shown in FIG. 6, in one embodiment, angle A may be about 60°. Further, as shown in FIG. 5, the base portion 80 may include side walls 90. The side walls 90 may be angled at an angle B relative to an extended plane of the bottom surface 88. In other words, the side walls 90 may not be exactly perpendicular to a plane extended laterally from the bottom surface 88. As shown in the embodiment of FIGS. 5 and 6, the angle B between the side walls 90 and an extended plane of the bottom surface 88 may be about 88°.

The insert 80 may further include a cutting portion as is generally indicated at 92 in FIGS. 5 and 6. The cutting portion 92 may have a generally triangular front face 94 that may lie generally in plane with the front surface 84 of the base portion 82 and/or in a position facing a direction of motion of a circular power groover blade upon which the insert 80 is mounted. The cutting portion 92 may also have a generally triangular rear face 96 that may lie generally in plane with the back surface 85 of the base portion 82. As shown in the embodiment of FIGS. 5 and 6, the front face 94 and rear face 96 may each be planar and spaced apart from one another and may be parallel to one another. A two-faceted roof surface 98 of the cutting portion 92 may extend between front surface 94 and rear surface 96, with the two generally parallelogram-shaped facets being joined at and defining a roof peak 99 that extends between respective apexes of the front and rear faces 94, 96. As best shown in FIG. 6, the peak 99 of the roof surface 98 may be angled at an angle C relative to the front face 94. In one embodiment, the angle C may be about 120°. The triangular front face 94 and the two parallelogram-shaped facets of the roof surface 98 cooperate to provide a cutting surface for cutting the v-shaped groove 48 when rotated by a power groover blade into engagement with a seam 46 between abutted sheets 40, 42. In one embodiment, the angle formed by the two facets of the roof surface 98 at the roof peak 99 may be about 90°.

In one embodiment, the cutting insert 80 may be carbide tipped for providing additional hardness to the cutting surface and for cutting a cleaner v-shaped groove 48 between sheets 40, 42. It will be appreciated that all or only a portion of the insert 80 comprise a carbide. Preferably, at least, the cutting portion 92 comprises carbide.

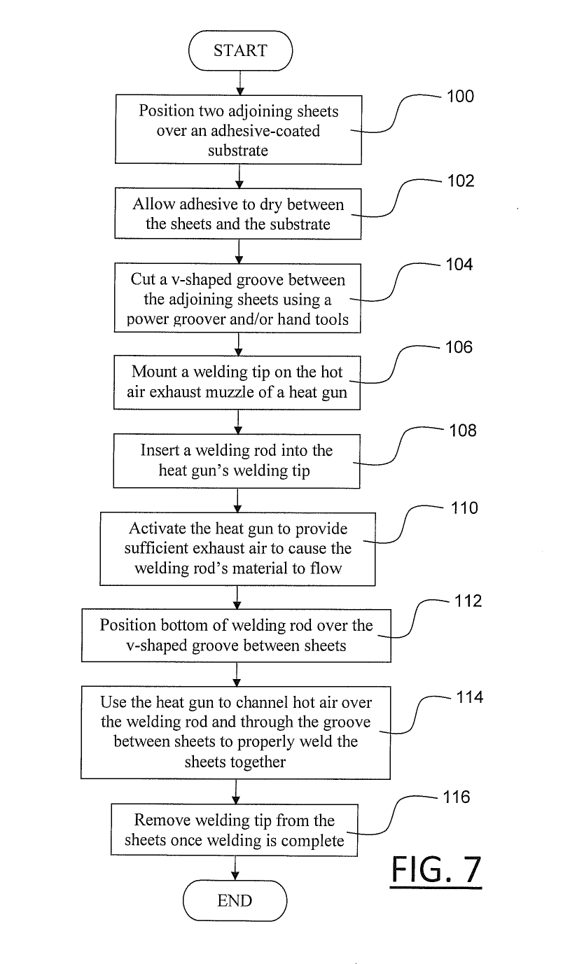

In practice, and as shown in the process flow chart of FIG. 7, two sheets 40, 42 may be welded together by first positioning the sheets 40, 42 over a substrate 44 having a suitable adhesive thereon as indicated in action step 100. The sheets 40, 42 may be positioned adjacent and may be abutting one another edgewise, i.e., edge-to-edge, so that there is provided a seam 46 therebetween. Once the adhesive has been allowed to cure between the sheets 40, 42 and the substrate 44 as indicated in action step 102, the v-shaped groove 48 may be cut between the sheets 40, 42 as indicated in action step 104. In one embodiment, the v-shaped groove is cut utilizing a power groover, (not shown) having a circular blade on which cutting inserts 80 are mounted in respective circumferentially spaced-apart positions such that rotation of the blade and engagement of the rotating inserts 80 to and along the seam 46 cuts the v-shaped groove 48 into and along the seam 46. In another embodiment, hand tools may be used to make the v-shaped groove 48 instead of a power groover and cutting inserts 80. These hand tools may include a utility knife and a straight edge (not shown). In either event, the v-shaped groove may preferably be uniformly formed into and along the seam 46 between the sheets 40, 42. In some embodiments, a power groover and hand tools may be utilized to form respective portions of a single v-shaped groove. In such a case, the v-shaped groove 48 may preferably be uniform between that portion formed by the power groover and that portion formed by hand using the hand tools. Further, the depth of the groove may preferably be greater than one-half of the thickness of the sheets 40, 42. Most preferably, the depth of the groove may be about three-quarters of the thickness of the sheets 40, 42. Accordingly, for a ¼″ sheet, the depth of the groove may be 3/16″.

As indicated in action step 106 of the FIG. 7 process flow chart, a welding tip 10 may be mounted on a heat gun. The welding tip 10 may be positioned such that the bottom 14 is positioned about a hot air exhaust muzzle of the hot air gun. As indicated in action step 108 a welding rod 60 may be positioned or inserted into the opening in the top 22 of the welding tip 10. The heat gun, having the welding tip 10 thereon, may be actuated and heated to exhaust air at a temperature, e.g., a temperature greater than 900° F., and more preferably, about 950° F., sufficient to cause the material of the welding rod 60 to flow, as indicated in action step 110. The heat settings for individual heat guns and temperature requirements for flowing different welding rod materials may vary. It is preferred, however, that in at least one embodiment the heat gun be set to achieve an exhaust air temperature greater than 900° F. and, preferably, about 950° F. as indicated above. Upon heating of the heat gun, and after a welding rod 60 has been positioned in the welding rod feed section 22, the tip 10 may be positioned over the v-shaped groove 48 such that the bottom 62 of the welding rod 60 is positioned into the v-shaped groove 48 as indicated in action step 112. As indicated in action step 114 the sheets 40, 42 may then be welded together by moving the heat gun and welding tip 10 along the groove 48 while feeding the welding rod 60 into the welding tip 10 and flowing molten welding rod material into and along the groove 48. The welding tip channels hot air from the heat gun through the oval opening 20 and over both the welding rod 60, and into the groove 48 formed along the seam 46 between the sheets 40, 42. It is desirable that the welding tip 10 provide heat to both the groove 48 and the rod 60 to properly weld the sheets 40, 42 together. According to one embodiment, the sheets 40, 42 may be welded together at a rate of up to about two linear feet per minute.

The heat gun may be held in a position such that the flange 30 of the welding tip 10 remains parallel with respective top surfaces 41, 43 of the sheets 40, 42. The flange 30 may preferably be held above the top surfaces 41, 43 of the sheets 40, 42, respectively, during the welding process. In order to aid in this positioning, the welding rod 60 may include the longitudinal ridge 70 as shown in FIG. 4. This longitudinal ridge 70 helps hold the flange 30, and thereby the welding tip 10, off the sheets 40, 42 at a desired level. The longitudinal ridge 70 also may aid in reducing the amount of trimming that may be necessary after the welding operation at least in part due to the consistent spacing between the flange 30 and the respective top surfaces 41, 43 of the sheets 40, 42. Once the seam 46 has been welded, the tip 10 may be removed from the sheets 40, 42 as indicated in action step 116 of FIG. 7. FIG. 3 shows a v-shaped groove 48 partially filled with the welding rod 60 material so as to achieve a weld between the sheets 40, 42. According to the embodiment of FIG. 3, the weld between the sheets 40, 42 includes an upper weld portion where the welding rod material is disposed in the v-shaped groove 48 is welded to both sheets 40, 42 along respective facing surfaces of the v-shaped groove 48, and a lower weld portion below the groove 48 where sufficient heat is transferred to directly weld together abutting material of sheets 40 and 42.

The foregoing description is considered illustrative only. The terminology that is used is intended to be in the nature of words of description rather than of limitation. Many modifications and variations will readily occur to those skilled in the art in view of the description. Thus, the foregoing description is not intended to limit the invention to the embodiments described above. Accordingly the scope of the invention as defined by the appended claims.

What is claimed is:

1. A method for heat welding plastic material, the method comprising:
providing a welding tip configured to slidably receive a welding rod and to direct a flow of hot air toward such a welding rod from a hot air source to melt a leading end of the rod as the welding rod is advanced therethrough;
positioning plastic sheets edgewise adjacent one another to form a seam therebetween;
cutting a v-shaped groove into and along the seam; and
welding the sheets together along the seam by feeding a welding rod through the welding tip while positioning and moving the welding tip adjacent and along the seam as the welding tip directs hot air to heat the welding rod and the sheets along the groove such that the welding rod flows into the groove and welds to respective sheet surfaces defining the groove.

2. The method of claim 1 in which the step of cutting a v-shaped groove includes cutting the groove to a depth less than the thickness of either sheet but great enough to allow sufficient heat to reach a lower end of the seam to insure that directly abutting material of the sheets flows together and welds at the lower end of the seam.

3. The method of claim 2 in which the step of cutting a v-shaped groove includes cutting the groove to a depth greater than on-half of the depth of at least one of the sheets.

4. The method of claim 1 in which the step of feeding a welding rod includes feeding a welding rod having the general shape of an elongated triangular prism.

5. A method for heat welding plastic material, the method comprising:
providing a welding tip configured to slidably receive a welding rod and to direct a flow of hot air toward such a welding rod from a hot air source to melt a leading end of the rod as the welding rod is advanced therethrough;
positioning plastic sheets having a depth, edgewise adjacent one another to form a seam therebetween;
cutting a groove into and along the seam such that the groove extends a depth less than the thickness of either sheet but great enough to allow sufficient heat to reach a lower end of the seam to insure that directly abutting material of the sheets flows together and welds at the lower end of the seam; and
welding the sheets together along the seam by feeding a welding rod through the welding tip while positioning and moving the welding tip adjacent and along the seam as the welding tip directs hot air to heat the welding rod and the sheets along the groove such that the welding rod flows into the groove and welds to respective sheet surfaces defining the groove.

6. The method of claim 5 in which the step of cutting a groove includes cutting a v-shaped groove into and along the seam.

7. The method of claim 6 in which the step of cutting a groove includes cutting the groove to a depth greater than on-half of the depth of at least one of the sheets.

8. The method of claim 6 in which the step of feeding a welding rod includes feeding a welding rod having the general shape of an elongated triangular prism.

9. A cutting insert for cutting a v-shape groove in plastic material, the cutting insert comprising:
a base portion configured to mount the insert to a blade of a power groover; and
a cutting portion having a v-shaped profile configured to cut a v-shaped groove in a surface when rotated into contact with such a surface by a power groover blade upon which the insert is mounted.

10. A cutting insert as set forth in claim 9 in which the cutting portion comprises carbide.

11. A cutting insert as set forth in claim 10 in which the insert includes a generally triangular front face having a first two edges defining the v-shaped profile of the cutting portion.

12. A cutting insert as set forth in claim 11 in which the insert includes a roof surface comprising two facets extending from the first two edges, respectively, and defining a roof peak between and along the two facets.

13. A cutting insert as set forth in claim 12 in which the angle between the two roof surface facets is approximately 90 degrees.

14. A cutting insert as set forth in claim 13 in which the angle between the roof peak and the front face is approximately 120 degrees.

15. A welding tip for welding plastic material, the welding tip comprising:
a welding rod feed section comprising a passage configured to slidably receive a welding rod;
a base secured to the welding rod feed section and configured to engage a heat gun exhaust muzzle and to direct the flow of hot air from the heat gun muzzle toward a welding rod carried by the feed section;
the feed section is configured to slidably receive and allow a welding rod having a generally triangular cross-section, to be advanced therethrough as a forward end of the welding rod is heated and melted by hot air directed by the base.

16. A welding tip as set forth in claim 15 in which the feed section has a generally triangular cross sectional shape along at least a portion of its length.

17. A welding tip as set forth in claim 15 in which the feed section has a cross-sectional shape that complements and is slightly larger than the cross-sectional shape of the welding rod.

18. A welding tip assembly for welding plastic material, the assembly comprising:
a welding rod;
a welding rod feed section comprising a passage configured to slidably receive a welding rod;
a base secured to the welding rod feed section and configured to engage a heat gun exhaust muzzle and to direct the flow of hot air from the heat gun muzzle toward a welding rod carried by the feed section; and
the welding rod has a general shape of an elongated triangular prism and the feed section is configured to slidably receive and allow the welding rod to be advanced therethrough as a forward end of the welding rod is heated and melted by hot air directed by the base.

19. A welding tip assembly as set forth in claim 18 in which the feed section has a generally triangular cross sectional shape along at least a portion of its length.

20. A welding tip assembly as set forth in claim 18 in which the feed section has a cross-sectional shape that complements and is slightly larger than the cross-sectional shape of the welding rod.

21. A welding tip assembly as set forth in claim 20 in which the welding rod includes a longitudinal ridge integrally extending from and along an upper surface of the rod.
